(19) United States
(12) Patent Application Publication
(10) Pub. No.: US 2011/0209686 A1
(43) Pub. Date: Sep. 1, 2011

(54) LOW OCTANE FUEL FOR GASOLINE COMPRESSION IGNITION

(76) Inventor: David M. McCann, Los Angeles, CA (US)

(21) Appl. No.: 13/037,791

(22) Filed: Mar. 1, 2011

Related U.S. Application Data
(60) Provisional application No. 61/309,355, filed on Mar. 1, 2010.

(51) Int. Cl. F02M 53/06; C10L 1/16

(52) U.S. Cl. 123/304; 123/305; 585/14

(57) ABSTRACT

The present invention provides an automotive fuel injection system for a compression ignition engine, comprising a fuel injector configured to receive a fuel having an octane rating between 87 and −30 and configured to meter the fuel into the compression ignition engine, and a heater coupled to the fuel injector and configured to heat the fuel injector such that the fuel is heated to a predetermined minimum temperature, whereby the ignition delay of the fuel is reduced below a predetermined maximum ignition delay.

### CROSS-REFERENCE TO RELATED APPLICATIONS

This application claims the benefit of U.S. Provisional Application No. 61/309,355 filed Mar. 1, 2010, which is hereby incorporated herein by reference in its entirety.

### BACKGROUND OF THE INVENTION

Conventional internal combustion engines do not include a compression ignition mode that operates using fuels having octane values less than about 87. More particularly, such internal combustion engines do not include direct injection fuel systems that reduce the physical compression ignition delay characteristics of fuel molecules. As a result, these engines are not adapted to run on fuels with lower compression ignition characteristics than diesel type fuels.

### BRIEF SUMMARY

According to various embodiments of the invention, systems are provided that allow the operation of an internal combustion engine in a compression ignition mode using fuels having octane values less than 87 and greater than −30. The invention provides direct injection fuel systems, including heated injection fuel systems that effectively reduce the physical compression ignition delay characteristics of fuel molecules. This allows the use of fuels with lower compression ignition characteristics than diesel type fuels (diesel type fuel being the portion between −250 to 350° C. in a petroleum distillation process.

One embodiment of the invention is directed toward a fuel injection system for a compression ignition engine, comprising: (i) a fuel injector configured to receive a fuel having an octane rating between 87 and −30 and configured to meter the fuel into the compression ignition engine; and (ii) a heater coupled to the fuel injector and configured to heat the fuel injector such that the fuel s heated to a predetermined minimum temperature, whereby the ignition delay of the fuel is reduced below a predetermined maximum ignition delay. The fuel is in a liquid phase when heated to the predetermined minimum temperature and when the fuel is metered into the compression ignition engine. The phase may comprise a supercritical fluid phase or a subcritical liquid phase.

Another embodiment of the invention is directed toward a fuel for a compression ignition engine, comprising a hydrocarbon fuel mixture having an octane rating between 87 and −30 and having an ignition delay that is less than a predetermined maximum ignition delay when heated to a predetermined minimum temperature and ignited through compression ignition in the compression ignition engine. The hydrocarbon fuel mixture may comprise pump gasoline mixed with a predetermined amount of a diesel fuel. The fuel may comprise a biofuel or synthetic fuel. In some cases, the ignition delay is less than the predetermined maximum ignition delay when the fuel is injected into the compression ignition engine in a vapor phase. This vapor phase may comprise a supercritical fluid phase or a subcritical liquid phase.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram of the fuel compression ignition process in an internal combustion engine, illustrating physical delay processes and chemical delay processes.

FIG. 2 illustrates a fuel supply system for a compression ignition engine according to an embodiment of the invention.

FIG. 3 is a graph presenting experimental ignition delay data of a variety of fuels implemented in accordance with an embodiment of the invention.

The figures are not intended to be exhaustive or to limit he invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

In homogenous charge compression ignition engines, the lack of a direct initiator of ignition (e.g., the spark in a spark ignition (gasoline) engine, or the boundary of fuel-air mixing, in a stratified charge (diesel) engine) causes inherent difficulties in control of the combustion process. Control over the ignition process and, consequently, engine operation may be increased through a reduction in the ignition delay of the fuel used in the engine.

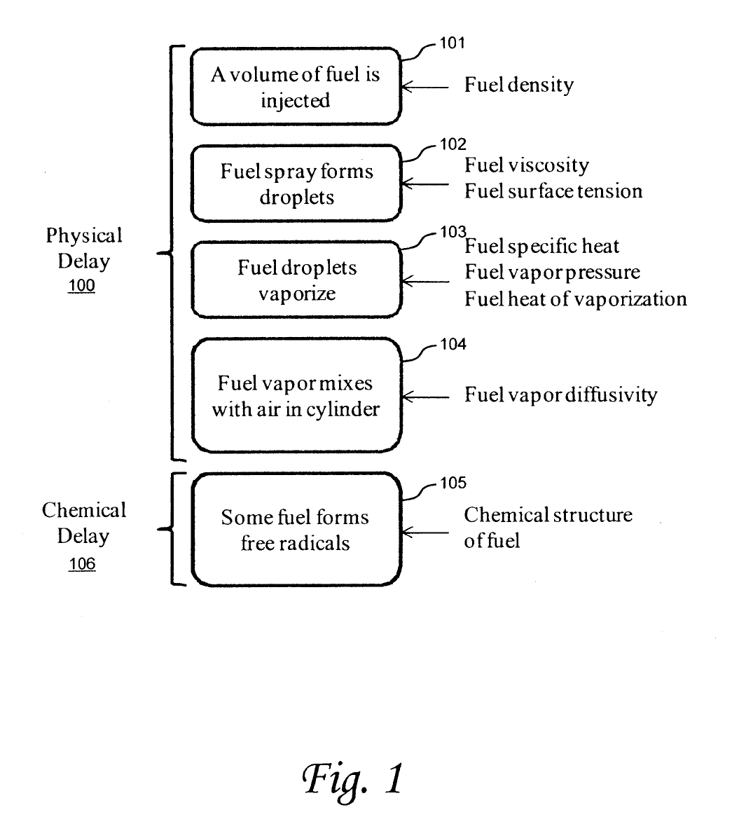

FIG. 1 illustrates physical and chemical processes that impact the compression ignition delay of fuels. In the ignition process, a volume of fuel is injected 101 into a combustion volume in a spray. Then, the fuel spray forms into droplets 102. The fuel droplets then vaporize 103 and the fuel vapor mixes 104 with air present in the combustion volume, here a cylinder of an internal combustion engine. Next, the fuel undergoes chemical processes such as the formation of free radicals 105. After these physical and chemical processes, the fuel ignites.

During the ignition process, various fuel characteristics introduce delay including physical delay 100 and chemical delay 106. During injection 101, fuel density impacts physical delay 100. During droplet formation 102, fuel viscosity and surface tension impact physical delay 100. During vaporization 103, the specific heat, vapor pressure, and heat of vaporization impact ignition delay (i.e., physical delay 100). During mixing 104, the fuel vapor diffusivity impacts ignition delay (i.e., physical delay 100). Finally, during the chemical ignition process, the chemical structure and composition of the fuel impacts chemical delay 106.

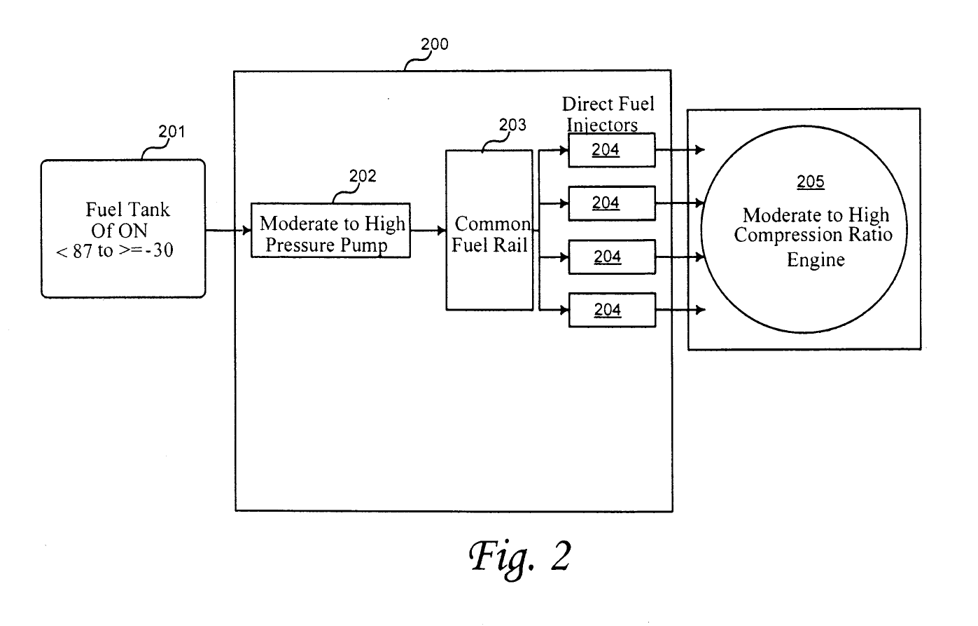

FIG. 2 illustrates a system for the use of low octane fuels according to an embodiment of the invention. In the illustrated embodiment, a fuel injection system 200 compensates for the physical delays in the combustion process, thereby reducing the ignition delay to allow for the use of low octane fuels in a compression ignition engine. A fuel tank 201 containing fuel having an octane value less than 87 and greater than or equal to −30 provides fuel for the fuel injection system 200.

The illustrated fuel injection system 200 comprises a moderate to high-pressure fuel pump 202 i.e. in a range of 4 to 210 MPa, with a preferred range of 14 to 32 MPa. The fuel pump 202 pumps fuel through a common fuel rail 203 to a plurality of direct fuel injectors 204. Here, a heat source is used to heat the fuel or ambient environment of the fuel to a predetermined minimum temperature before it is injected into the engine 205. By way of example, a range of 12:1-20:1 compression ratio may be employed. Through this heating, the ignition delays are reduced such that fuels having octane ratings (ON) between 87 and −30 may be used in engine 205, with a preferred ON range of between 50 and 65.

In some embodiments, fuel injectors 204 directly inject fuel into the engine 205 as a liquid. This may comprise heating the fuel, and optionally pressurizing the fuel, such that the fuel is present in a supercritical fluid phase. In other embodiments, the phase of the fuel comprises a sub-critical liquid phase. In these embodiments, heating the fuel comprises heating the fuel to a predetermined minimum temperature. This enables the use of a fuel 201 comprising a gasoline type fuel with an octane rating less than 87 and greater than or equal to −30. In some embodiments, fuel with these octane ratings may be produced through mixing mainstream gasoline type fuel (having octane ratings greater than or equal to 87) with diesel fuel or other low octane fuels. In other embodiments, the fuel may be produced directly through petroleum distillation or other fuel production methods.

In some embodiments, it may be difficult to directly determine the fuel temperature before it is metered into the engine. Accordingly, heating the fuel to the predetermined minimum temperature may be achieved by heating the fuel injector to a temperature determined to heat the fuel to the predetermined minimum temperature. In some embodiments, the fuel injectors may be heated to temperatures between 100 ° C. and 550 ° C., which results in the fuels being heated to the proper temperature for the desired ignition delay value. In other embodiments, heating elements may be disposed in the fuel injectors to allow heating of the fuel. In further embodiments, the specific temperature to which the injector is heated is dependent on (i) the octane rating of the specific fuel being used, and (ii) the ignition delay desired for compression engine operation.

In some embodiments, the reduced ignition delays achieved through fuel heating may enable the use of fuels having octane ratings between 87 and −30 without the use of additional fuel conditioning processes. For example, catalytic cracking or reformation, or blending the fuel with non-standard additives or water is not required for operating the moderate to high compression ignition engine because of the reduced ignition delays achieved through this invention.

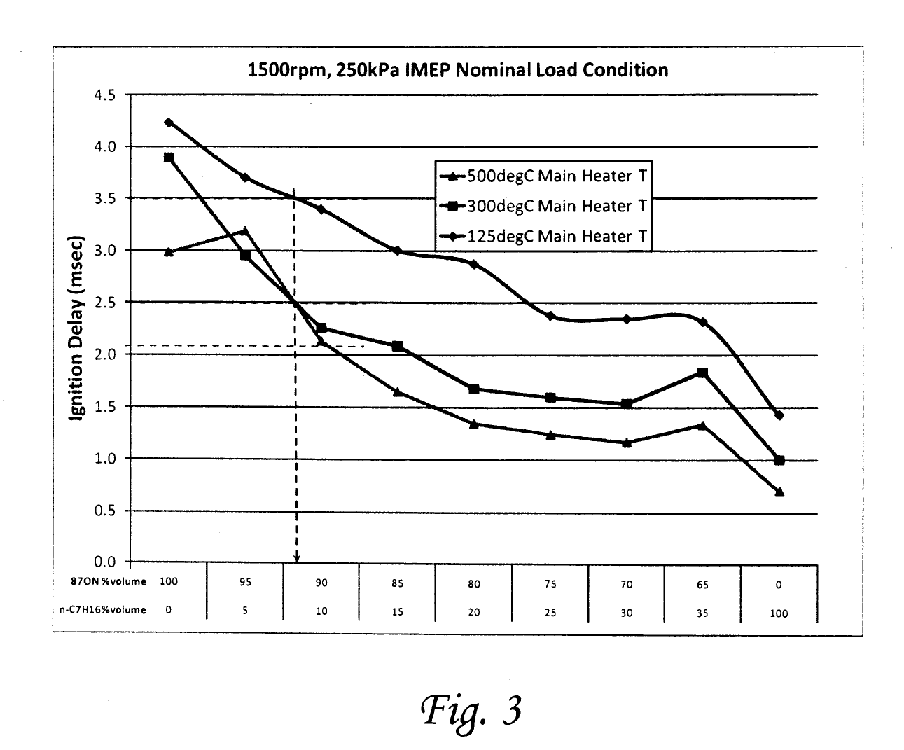

FIG. 3 illustrates the ignition delays of fuels having various octane ratings when heated to certain minimum temperatures. The experiments to determine these data were performed on a high compression ignition engine utilizing heated injection. The fuels were created by mixing n-heptane (n-C₇H₁₆), which has a Research octane number of 0, with 87 ON pump gasoline. The engine test conditions included 1500 rpm with a load of 250 kPA Indicated Mean Effective Pressure. As these results show, significant ignition delay reduction may be accomplished by heating a fuel injector to a predetermined minimum temperature, where the predetermined minimum temperature is determined according to the octane rating of the fuel. Utilizing current technologies available, for example exhaust gas recycling, an ignition delay of between 0.5 and 3.0 msecs is controllable, with a preferred range of between 0.7 and 1.5 msec. For example, a fuel consisting of 90% vol. 87 ON pump gas and 10% vol. n-heptane had an ignition delay of less than 2.5 msec when a fuel injector used to inject the fuel was heated to a minimum temperature of approximately 300 ° C.

As used herein, the term gasoline type fuel refers to a hydrocarbon composition found with the common “Gasoline” distillation cut of petroleum refineries, i.e. <200° C. (moderate molecular weight). The term also refers to biofuels composed of renewable resources or other synthetic fuels having similar chemical properties or compression ignition characteristics (for example molecular weight, carbon chain length, density) as gasoline distillation cut fuels. In still further embodiments, natural gas or other similar fuels may be used in the fuel systems disclosed herein.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or o an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A fuel injection system for a compression ignition engine, comprising:
a fuel injector configured to receive a fuel having an octane rating between 87 and −30 and configured to meter the fuel into the compression ignition engine; and
a heater coupled to the fuel injector and configured to heat the fuel injector such that the fuel is heated to a predetermined minimum temperature, whereby the ignition delay of the fuel is reduced below a predetermined maximum ignition delay.

2. The fuel injection system of claim 1, wherein the fuel is in a liquid phase when heated to the predetermined minimum temperature and when the fuel is metered into the compression ignition engine.

3. The fuel injection system of claim 2, wherein the phase comprises a supercritical fluid phase.

4. The fuel injection system of claim 2, wherein the phase comprises a subcritical liquid phase.

5. A fuel for a compression ignition engine, comprising:
a hydrocarbon fuel mixture having an octane rating between 87 and −30 and having an ignition delay that is less than a predetermined maximum ignition delay when heated to a predetermined minimum temperature and ignited through compression ignition in the compression ignition engine.

6. The fuel of claim 5, wherein the hydrocarbon fuel mixture comprises pump gasoline mixed with a predetermined amount of a diesel fuel.

7. The fuel of claim 5, wherein the fuel comprises a biofuel or synthetic fuel.

8. The fuel of claim 5, wherein the ignition delay is less than the predetermined maximum ignition delay when the fuel is injected into the compression ignition engine in a vapor phase.

9. The fuel of claim 8, wherein the vapor phase comprises a supercritical fluid phase.

10. The fuel of claim 8, wherein the phase comprises a subcritical liquid phase.

11. An apparatus, comprising:
a fuel injector configured to receive a fuel having an octane rating between 87 and −30 and configured to meter the fuel into the compression ignition engine; and
a heater coupled to the fuel injector and configured to heat the fuel injector such that the fuel is heated to a predetermined minimum temperature, whereby the ignition delay of the fuel is reduced below a predetermined maximum ignition delay;
wherein the fuel is in a liquid phase when heated to the predetermined minimum temperature and when the fuel is metered into the compression ignition engine.

12. The fuel injection system of claim 2, wherein the phase comprises a supercritical fluid phase.

13. The fuel injection system of claim 2, wherein the phase comprises a subcritical liquid phase.

14. A fuel for a compression ignition engine, comprising:
a hydrocarbon fuel mixture having an octane rating between 87 and −30 and having an ignition delay that is less than a predetermined maximum ignition delay when heated to a predetermined minimum temperature and ignited through compression ignition in the compression ignition engine;
wherein the hydrocarbon fuel mixture comprises pump gasoline mixed with a predetermined amount of a diesel fuel.

15. The fuel of claim 5, wherein the fuel comprises a biofuel or synthetic fuel.

16. The fuel of claim 5, wherein the ignition delay is less than the predetermined maximum ignition delay when the fuel is injected into the compression ignition engine in a vapor phase.

17. The fuel of claim 8, wherein the vapor phase comprises a supercritical fluid phase.

18. The fuel of claim 8, wherein the phase comprises a subcritical liquid phase.
